(19) United States
(12) Patent Application Publication
(10) Pub. No.: US 2024/0292847 A1
(43) Pub. Date: Sep. 5, 2024

(54) BAKING ADDITIVE

(71) Applicant: Novozymes A/S, Bagsvaerd (DK)

(72) Inventor: Alexander Findeisen, Bagsvaerd (DK)

(73) Assignee: Novozymes A/S, Bagsvaerd (DK)

(21) Appl. No.: 17/777,718

(22) PCT Filed: Dec. 9, 2020
(86) PCT No.: PCT/EP2020/085333

§ 371 Date: May 18, 2022

(30) Foreign Application Priority Data
Dec. 9, 2019 (EP) 19214538.1

(51) Int. Cl. A21D 8/04; A21D 2/16; A21D 2/22; A21D 10/00

(52) U.S. Cl. CPC A21D 8/042; A21D 2/165; A21D 2/22; A21D 10/005

(57) ABSTRACT

The invention provides an enzymatic baking additive comprising enzyme particles, oil, and diluent particles, which exhibit low dust and excellent flowability properties.

### FIELD OF THE INVENTION

The present invention relates to a highly concentrated enzymatic baking additive, which has low dust and excellent flowability properties.

### BACKGROUND

Enzymes have been used in the baking industry for many years. They have typically been supplied as powdered/granulated products, intended to be added in the baking process together with flour and other ingredients. Naturally occurring allergens in flour has for many years been a concern in the baking industry; however, the increased awareness of a safe working environment also requires new and improved enzyme formulations that reduce enzyme dust emissions during preparation and processing of dough for baked products.

New recommendations suggest an occupational exposure limit for fungal alpha-amylase of 10 ng/m³, as a time-weighted 8 hours personal exposure limit. Other enzyme classes used in the baking industry may require similar occupational exposure limits. Thus, a need for dedusted baking enzyme products exists.

However, while solving the safety aspects of enzyme formulations, other important physical properties, like homogeneity (low segregation) and flowability, must be maintained. These parameters are critically important for handling and dosing accuracy in the industrial production of baked products. Also, if the enzyme is mixed with high amounts of dust-capturing materials, the enzyme concentration may be significantly reduced, which will increase the amounts and the handling complexity.

The particle size is another important property of powder ingredients in the baking industry. For the European market the current spec of 212 μm is reflecting a French regulation from 1985, but many markets all over the world tend to use wheat flour (determining the size of the enzyme formulation) with even smaller particles (130-150 μm).

From the prior art, numerous solid enzyme compositions are known which are produced, to make the handling safer, prevent segregation and being able to apply the right amount of enzyme to the final baked good:

US 2009/0317515 discloses a solid enzyme formulation obtained by mixing a salt-stabilized enzyme powder with a diluent and a hydrophobic liquid.

US 2010/0310720 describes a bakery enzyme composition comprising a carrier of starch or flour (in the range of 85-99.5% w/w) and optionally an oil in an amount of 0.01 to about 2%.

WO 2019/115669 relates to an enzyme granulate comprising an enzyme powder, a diluent (concentration not stated, examples in the range of 80% w/w and higher) and a vegetable oil (0.015 to 0.4% w/w).

US 2002/0028267 describes a method for the production of an activity stable and low dust enzyme granulate for use in the food industry, comprising 0.01 to 20% w/w of enzyme and 80 to 99.99% w/w of an organic flour type with a degree of grinding of 30% to 100%.

US 2005/054065 describes a process to produce low dust phytase granules by mixing liquid phytase concentrate with 15-80% w/w carbohydrate polymer (like starches).

EP 867116 describes a low dusting extruded (cylindrical) baking ingredient mix containing enzymes, an emulsifier of melting point 10-60° C. and other ingredients that are commonly used in the baking industry.

WO 2016/114648 relates to a granular de-dusting material comprising 30-60% w/w cold-swelling potato starch, 5-40% w/w vegetable oil and 5-35% w/w flour.

As described above, there is a need for baking enzyme products having low dust emission, high enzyme concentration, high flowability, and low segregation (high homogeneity). While the prior art discloses products having some of these properties, there remains a need for a baking enzyme product that combines all of these properties.

### SUMMARY OF THE INVENTION

The present invention provides, in a first aspect, a (homogenous) baking additive powder comprising, or consisting essentially of:
(a) 30-70% w/w enzyme particles having a mass median diameter (D₅₀) of 20-200 μm,
(b) 0.05-5% w/w of oil, and
(c) non-enzymatic diluent particles having a Stokes diameter of 130-220 μm with a span of less than 2.

Other aspects and embodiments of the invention are apparent from the description and examples.

Unless otherwise indicated, or if it is apparent from the context that something else is meant, all percentages are percentage by weight (% w/w).

Unless otherwise indicated, all particle sizes are the volume based particle diameter, and the average particle size is the volume average particle diameter (which is the same as the weight based particle diameter, if the densities of the particles are the same). Particle size may be measured using laser diffraction methods or optical digital imaging methods or sieve analysis.

### FIGURES

FIG. 1 shows the scooping box set-up used in the examples.

FIG. 2 shows a typical dust response measured by DustTrack DRX in the examples.

### DETAILED DESCRIPTION

It is well-known that powders can be dedusted by adding oil to the powder composition. However, this also induces stickiness to the powder, and physical force must be applied to separate the particles and reinstate free flowing behavior. This can be achieved by adding bigger and/or heavier particles, but most often, this also results in segregation of the resulting powder composition because of the different properties of the particles.

We have found that the Stokes diameter is useful to characterize particles exhibiting low segregation in a mixed enzyme particle composition, despite differences in particle diameters, densities and shapes. This can be used to provide a particulate enzyme composition, which is both free-flowing and does not segregate.

The Stokes diameter is normally used to characterize the behavior of solid particles in a liquid, but in some conditions powders also behave like liquids. A well-known example is fluidization of a powder in a fluidized bed spray coater. The powders of the invention are not fluidized; however, when transporting or mixing such powders, they also exhibit a behavior similar to liquids, which can result in segregation of different particle components.

We have found that it is possible to make a non-segregating baking additive powder, where sufficient amounts of oil for dedusting can be added, while retaining acceptable flowability (dynamic angle of repose <60°) and a high content of enzyme particles (>30% w/w), by adding an adjunct material (diluent particles) having a Stokes diameter in the range of 130-220 μm before mixing, and having a narrow span (<2). The purpose of the narrow span is to ensure that the measured Stokes diameter closely applies to all diluent particles.

The use of the Stokes diameter to characterize enzyme particle interactions in a bulk of powder has not been described before. The Stokes diameter is generally used to describe how particles settle in liquids, but not how particle behave in a powder composition.

Based on these findings, the present invention provides a baking additive comprising, or consisting essentially of:
(a) 30-70% w/w of enzyme particles having a mass median diameter (D₅₀) of 20-200 μm,
(b) 0.05-5% w/w of oil, and
(c) non-enzymatic diluent particles having a Stokes diameter of 130-220 μm with a span of less than 2.

The baking additive may also contain other minors, such as processing aids, that does not interfere with the properties of the composition.

### Stokes Diameter

Particle size can be determined by many well-known methods, such as sieve analysis; minimum or maximum or average diameter of projected area from particle, etc.

Another way of describing the particle size is to use the Stokes diameter, which is measured by a sedimentation analysis based upon Stokes' Law. A single solid sphere settling in a fluid has a terminal settling velocity, which is uniquely related to its diameter, shape and density.

Stokes' law is applicable to laminar conditions. This is fulfilled with the materials and particle sizes used in the below mentioned Examples. The (particle) Reynolds numbers were calculated to between 0.3-5, which is low and within or very close to the laminar region.

By measuring the gravity-induced settling velocities of different particles in a liquid with known properties and constant temperature, the spherical equivalent particle sizes can be determined. The rate at which the particles fall through a liquid is described by Stokes' Law as follows (see also Jain et al., Theory and Practice of Physical Pharmacy, Elsevier 2012):

$${d}_{stokes} = \sqrt{\frac{18 {μ}_{medium} {u}_{settle}}{g ( {ρ}_{particle} - {ρ}_{medium} )}}$$

where μ_{medium} is the viscosity of the surrounding medium, uₛₑₜₜₗₑ is the measured velocity of the particles in the liquid, g is the gravity constant, and ρ_{particle}−ρ_{medium} is the difference between the particle density and the density of the medium. By determining the velocity of the particle in the liquid (uₛₑₜₜₗₑ), the deviation from a spherical particle shape is taken into account.

The determination of the Stokes diameter is explained in detail in Example 3.

### Angle of Repose

The term “angle of repose” characterizes the flowability of a granular/particulate material. When bulk granular materials are poured onto a horizontal surface, a conical pile will form. The internal angle between the surface of the pile and the horizontal surface is known as the angle of repose and is related to the density, surface area and shapes of the particles, and the coefficient of friction of the material. The angle of repose can range from 0° to 90°. Material with a low angle of repose forms flatter piles and has better flowability than material with a high angle of repose.

In establishing a relation between flowability of powders and a simple physical measure, it is well-known to use the angle of repose to characterize the flowability. An angle of repose of less than 60 degrees is considered acceptable for industrial application of baking enzymes.

### Span

The span of a particle composition is a well-known property that quantifies the width of the corresponding particle distribution: (D₉₀-D₁₀)/D₅₀.

The calculation includes two points (D₁₀ and D₉₀) describing each “end” of the distribution. Using the same convention as the D₅₀, the D₉₀ describes the diameter where 90% of the particles in the distribution has a smaller particle size and 10% has a larger particle size. Likewise, the D₁₀ describes the diameter where 10% of the particles in the distribution has a smaller particle size and 90% has a larger particle size.

### Enzyme Particles

The enzyme particles used to prepare the baking additive of the invention have a mass median diameter (D₅₀) of 20-200 μm.

Further, the enzyme particles may comprise at least 0.1% w/w of active enzyme protein, and be produced by any suitable method known in the art. Preferably, the enzyme particles are produced by spray drying. A liquid enzyme preparation may be processed to a dry enzyme particle, for example, by spray drying. Spray drying is a method for producing a dry powder or dry particle/particulate from a liquid or a slurry, which is well-known to a person skilled in the art. In spray drying, a liquid (aqueous) enzyme solution will be atomized (sprayed in small droplets) into a heated chamber to bring the droplets in contact with a hot air flow (such as 110° C. to 190° C.). When the liquid evaporates, solid enzyme particles will be formed. The enzyme solution and the resulting enzyme particles may also contain processing aids, such as binders, fillers, etc.

The baking additive comprises the enzyme particles in an amount of 30-70% w/w.

### Oil

The oil used to prepare the baking additive is liquid at room temperature. Any suitable vegetable oil can be used, but preferably the oil is an edible vegetable oil. An edible vegetable oil may comprise sunflower oil, palm oil, coconut oil, MCT oil (medium-chain triglyceride), soy oil, rapeseed oil, and/or canola oil.

The baking additive comprises the oil in an amount of 0.05-5% w/w.

### Diluent Particles

The diluent particles used in the baking additive have a Stokes diameter of 130-220 μm with a span of less than 2.

All powders derived from carbohydrate polymers and inorganic materials that can be used for food application, can be used as diluent particles in the baking additive.

Since the Stokes diameter depends on the density of the material, there is an interrelation between the choice of material and the sieved particle size needed to achieve a certain Stokes diameter.

It is advantageous to use diluent particles having a particle density of more than 1500 kg/m³, preferably more than 1600 kg/m³, because a higher density can be used to lower the particle size and thereby reduce the volume of diluent particles. This reduces costs of manufacturing and handling, and also allows for a higher volume of enzyme particles in the baking additive powder.

Particularly preferred materials for making the diluent particles are salts and sugars, in particular salts and sugars having a particle density of more than 1500 kg/m³, preferably more than 1600 kg/m³.

The salts and sugars are any salt and sugar compatible with baking and baked products, and as such they may also be edible, i.e., suitable for use in food.

Preferred salts are sodium chloride and potassium chloride. Other suitable salts include sodium phosphates, sodium carbonates, sodium sorbates, sodium acetates, sodium lactates, sodium ascorbates, sodium glutaminates; potassium phosphates, potassium carbonates, potassium sorbates, potassium acetates, potassium lactates, potassium ascorbates, and potassium glutaminates.

Suitable sugars include monosaccharides and oligosaccharides such as disaccharides and trisaccharides. Monosaccharides may be glucose, mannose, galactose, and fructose. Disaccharides may be sucrose, maltose, trehalose, isomaltose, and lactose. Trisaccharides may be maltotriose and raffinose. Other oligosaccharides may include fructo-oligosaccharides, inulin, dextrin or maltodextrin.

The diluent particles may also contain sugar alcohols, such as sorbitol, mannitol, lactitol and xylitol.

The salts and/or sugars may provide advantageous properties to the dough, and thus, the diluent particles may become an active ingredient (contrary to flour), and the baking additive will act as a convenient co-formulation of enzyme(s) and other active baking ingredients. For example, carbonates can be used as rising agents (baking powder), sorbates can be used as preservation agents, and ascorbates (or ascorbic acid) can be used as an antioxidant and dough conditioner. Such advantageous properties are readily recognized by a person skilled in the art.

The diluent particles may be made from combinations of the above-mentioned salts and sugars, and in such particles the sugar may also act as a binding agent.

The baking additive may comprise the diluent particles in an amount of 29-65% w/w.

### Enzymes

The enzyme particles used in the baking additive of the invention has a mass median diameter (D₅₀) of 20-200 μm, preferably 50-200 μm, and most preferably 100-200 μm. The enzymes are catalytic proteins, and the term “active enzyme protein” is defined herein as the amount of catalytic protein(s), which exhibits enzymatic activity. This can be determined using an activity based analytical enzyme assay. In such assays, the enzyme typically catalyzes a reaction generating a colored compound. The amount of the colored compound can be measured and correlated to the concentration of the active enzyme protein. This technique is well-known in the art. The active enzyme protein may be fungal or bacterial enzyme(s).

The enzyme(s) used in the preparation of, and as a component of, the baking additive is(are) any enzyme suitable for use in baking. In particular the enzyme(s) is(are) selected from the group consisting of aminopeptidase, amylase, alpha-amylase, maltogenic alpha-amylase, beta-amylase, lipolytic enzymes, carboxypeptidase, catalase, chitinase, cutinase, cyclodextrin glycosyltransferase, deoxyribonuclease, esterase, galactanase, glucan 1,4-alpha-maltotetrahydrolase, glucanase, alpha-galactosidase, beta-galactosidase, glucoamylase, alpha-glucosidase, beta-glucosidase, hemicellulase, haloperoxidase, invertase, laccase, mannanase, mannosidase, oxidase, pectinolytic enzymes, peptidoglutaminase, peroxidase, phospholipase, phytase, polyphenoloxidase, proteolytic enzyme, ribonuclease, transglutaminase, xylanase, and mixtures thereof.

The glucoamylase may have a sequence identity of at least 50%, at least 60%, at least 65%, at least 70%, at least 75%, at least 80%, at least 85%, at least 90%, at least 95%, at least 96%, at least 97%, at least 98%, or at least 99% to the amino acid sequence of the Aspergillus niger G1 or G2 glucoamylase (Boel et al. (1984), EMBO J. 3 (5), p. 1097-1102), the A. awamori glucoamylase disclosed in WO 84/02921, or the A. oryzae glucoamylase (Agric. Biol. Chem. (1991), 55 (4), p. 941-949).

The amylase may be fungal or bacterial, e.g., a maltogenic alpha-amylase from B. stearothermophilus or an alpha-amylase from Bacillus, e.g. B. licheniformis or B. amyloliquefaciens, a beta-amylase, e.g., from plant (e.g. soy bean) or from microbial sources (e.g., Bacillus), or a fungal alpha-amylase, e.g., from A. oryzae.

The maltogenic alpha-amylase may also be a maltogenic alpha-amylase as disclosed in, e.g., WO1999/043794; WO2006/032281; or WO2008/148845.

Suitable commercial maltogenic alpha-amylases include NOVAMYL, OPTICAKE 50 BG, and OPTICAKE 3D (available from Novozymes A/S). Suitable commercial fungal alpha-amylase compositions include BAKEZYME P 300 (available from DSM) and FUNGAMYL 2500 SG, FUNGAMYL 4000 BG, FUNGAMYL 800 L, FUNGAMYL ULTRA BG and FUNGAMYL ULTRA SG (available from Novozymes A/S).

An anti-staling amylase may also be an amylase (glucan 1,4-alpha-maltotetrahydrolase (EC 3.2.1.60)) from, e.g., Pseudomonas, such as any of the amylases disclosed in WO1999/050399. WO2004/111217, or WO2005/003339.

The glucose oxidase may be a fungal glucose oxidase, in particular an Aspergillus niger glucose oxidase (such as GLUZYME®, available from Novozymes A/S).

The lipolytic enzyme is an enzyme (EC 3.1.1) having lipase, phospholipase and/or galactolipase activity; especially an enzyme having lipase and phospholipase activity.

The lipase exhibit triacylglycerol lipase activity (EC 3.1.1.3), i.e., hydrolytic activity for carboxylic ester bonds in triglycerides, e.g., tributyrin.

The phospholipase exhibit phospholipase activity (A1 or A2, EC 3.1.1.32 or 3.1.1.4), i.e., hydrolytic activity towards one or both carboxylic ester bonds in phospholipids such as lecithin.

The galactolipase exhibit galactolipase activity (EC 3.1.1.26), i.e., hydrolytic activity on carboxylic ester bonds in galactolipids such as DGDG (digalactosyl diglyceride).

The hemicellulase may be a pentosanase, e.g., a xylanase which may be of microbial origin, e.g., derived from a bacterium, such as a strain of Bacillus, in particular a strain of B. subtilis, or a strain a strain of Pseudoalteromonas, in particular P. haloplanktis, or derived from a fungus, such as a strain of Aspergillus, in particular of A. aculeatus, A. niger, A. awamori, or A. tubigensis, from a strain of Trichoderma, e.g., T. reesei, or from a strain of Humicola, e.g., H. insolens.

Suitable commercially available xylanase preparations for use in the present invention include PANZEA BG, PENTOPAN MONO BG and PENTOPAN 500 BG (available from Novozymes A/S), GRINDAMYL POWERBAKE (available from DuPont), and BAKEZYME BXP 5000 and BAKEZYME BXP 5001 (available from DSM).

The protease may be from Bacillus, e.g., B. amyloliquefaciens or from Thermus aquaticus.

### Dough

In one aspect, the invention discloses a method for preparing dough, or a baked product prepared from the dough, which method comprises incorporating into the dough the baking additive of the invention.

The present invention also relates to methods for preparing a dough or a baked product comprising incorporating into the dough an effective amount of the baking additive of the invention which improves one or more properties of the dough or the baked product obtained from the dough, when compared to a dough or a baked product in which the baking additive is not incorporated.

The phrase “incorporating into the dough” is defined herein as adding the baking additive of the invention to the dough, to any ingredient from which the dough is to be made, and/or to any mixture of dough ingredients from which the dough is to be made. In other words, the baking additive of the invention may be added in any step of the dough preparation and may be added in one, two or more steps. The baking additive is added to the ingredients of dough that may be kneaded or mixed and baked to make the baked product using methods well known in the art.

The term “effective amount” is defined herein as an amount of the baking additive of the invention that is sufficient for providing a measurable effect on at least one property of interest of the dough and/or baked product.

Non-limiting examples of properties of interest are dough tolerance, rheology (stickiness, elasticity, extensibility) and machinability, baked product volume, softness, resilience, cohesiveness, elasticity, crust colour, sliceability, short bite.

The term “dough” is defined herein as a mixture of flour and other ingredients firm enough to knead or roll. In the context of the present invention, batters are encompassed in the term “dough”.

The dough of the method of the invention may comprise flour derived from any cereal grain or other sources, including wheat, emmer, spelt, einkorn, barley, rye, oat, corn, sorghum, rice, millet, amaranth, quinoa, and cassava.

The dough may also comprise other conventional dough ingredients, e.g., proteins, such as milk powder, gluten, and soy; eggs (either whole eggs, egg yolks, or egg whites); an oxidant such as ascorbic acid, potassium bromate, potassium iodate, azodicarbonamide (ADA) or ammonium persulfate; an amino acid such as L-cysteine; a sugar; a salt such as sodium chloride, calcium acetate, sodium sulfate, or calcium sulfate, gum(s), fibre(s), preservatives, and/or an emulsifier.

The dough may comprise one or more lipid material (such as e.g. margarine, butter, oil, shortening), eventually in granular form.

The dough may be gluten-free dough.

The dough of the method of the invention may be fresh, frozen or par-baked (pre-baked).

The dough of the method of the invention is a non-leavened dough, a leavened dough or a dough to be subjected to leavening.

### Emulsifiers

For some applications, an emulsifier is not needed; for some applications an emulsifier may be needed.

A suitable emulsifier is preferably an emulsifier selected from the group consisting of diacetyl tartaric acid esters of monoglycerides (DATEM), sodium stearoyl lactylate (SSL), calcium stearoyl lactylate (CSL), ethoxylated mono- and diglycerides (EMG), distilled monoglycerides (DMG), polysorbates (PS), succinylated monoglycerides (SMG), propylene glycol monoester, sorbitan emulsifiers, polyglycerol esters, sucrose esters and lecithin.

In some applications, a lipolytic enzyme may replace part, or even all, of the emulsifier(s) usually present in the dough recipe.

### Baked Product

The process of the invention may be used for any kind of baked product prepared from dough, particular of a soft character, either of a white, light or dark type. Non-limiting examples are bread (in particular white, whole-meal or rye bread), typically in the form of loaves or rolls, soft rolls, bagels, donuts, Danish pastry, puff pastry, laminated baked products, steamed buns, hamburger rolls, pizza, pita bread, ciabatta, sponge cakes, cream cakes, pound cakes, muffins, cupcakes, steamed cakes, waffles, brownies, cake donuts, yeast raised donuts, baguettes, rolls, crackers, biscuits, cookies, pie crusts, rusks and other baked products.

Further embodiments of the invention include:

### Embodiment 1

A baking additive powder comprising
(a) 30-70% w/w of enzyme particles having a mass median diameter (D₅₀) of 20-200 μm,
(b) 0.05-5% w/w of oil, and
(c) non-enzymatic diluent particles having a Stokes diameter of 130-220 μm with a span of less than 2.

### Embodiment 2

A baking additive powder consisting essentially of
(a) 30-70% w/w of enzyme particles having a mass median diameter (D₅₀) of 20-200 μm,
(b) 0.05-5% w/w of oil, and
(c) non-enzymatic diluent particles having a Stokes diameter of 130-220 μm with a span of less than 2.

### Embodiment 3

A baking additive powder consisting of
(a) 30-70% w/w of enzyme particles having a mass median diameter (D₅₀) of 20-200 μm,
(b) 0.05-5% w/w of oil, and
(c) non-enzymatic diluent particles having a Stokes diameter of 130-220 μm with a span of less than 2.

### Embodiment 4

The baking additive of any of embodiments 1-3, wherein the enzyme particles comprise at least 0.1% w/w of active enzyme protein.

### Embodiment 5

The baking additive of any of embodiments 1-4, wherein the enzyme particles are prepared by spray drying.

### Embodiment 6

The baking additive of any of embodiments 1-5, which comprises 40-70% w/w of the enzyme particles.

### Embodiment 7

The baking additive of any of embodiments 1-6, wherein the enzyme is selected from the group consisting of amylase, oxidase, lipolytic enzyme, hemicellulase, and combinations thereof.

### Embodiment 8

The baking additive of any of embodiments 1-7, wherein the enzyme is an amylase and/or a lipolytic enzyme.

### Embodiment 9

The baking additive of any of embodiments 1-8, wherein the enzyme particles have a mass median diameter (D₅₀) of 20-200 μm.

### Embodiment 10

The baking additive of any of embodiments 1-9, wherein the enzyme particles have a mass median diameter (D₅₀) of 50-200 μm.

### Embodiment 11

The baking additive of any of embodiments 1-10, wherein the enzyme particles have a mass median diameter (D₅₀) of 100-200 μm.

### Embodiment 12

The baking additive of any of embodiments 1-11, wherein the oil comprises an edible vegetable oil.

### Embodiment 13

The baking additive of any of embodiments 1-12, wherein the oil is an edible vegetable oil.

### Embodiment 14

The baking additive of any of embodiments 1-13, which comprises 0.07-3% of the oil.

### Embodiment 15

The baking additive of any of embodiments 1-14, wherein the oil comprises an oil selected from the group consisting of sunflower oil, palm oil, coconut oil, MCT oil, soy oil, rapeseed oil, canola oil, and combinations thereof.

### Embodiment 16

The baking additive of any of embodiments 1-15, wherein the oil is selected from the group consisting of sunflower oil, palm oil, coconut oil, MCT oil, soy oil, rapeseed oil, canola oil, and combinations thereof.

### Embodiment 17

The baking additive of any of embodiments 1-16, which comprises 20-69% w/w of the diluent particles.

### Embodiment 18

The baking additive of any of embodiments 1-17, wherein the diluent particles have a particle density of more than 1500 kg/m³.

### Embodiment 19

The baking additive of any of embodiments 1-18, wherein the diluent particles have a particle density of more than 1600 kg/m³.

### Embodiment 20

The baking additive of any of embodiments 1-19, wherein the diluent particles comprise one or more salts and/or sugars.

### Embodiment 21

The baking additive of any of embodiments 1-20, wherein the diluent particles consist of one or more salts and/or sugars.

### Embodiment 22

The baking additive of any of embodiments 1-21, wherein the diluent particles comprise one or more salts, and optionally a sugar binding agent.

### Embodiment 23

The baking additive of any of embodiments 1-22, wherein the diluent particles consist of one or more salts, and optionally a sugar binding agent.

### Embodiment 24

The baking additive of any of embodiments 20-23, wherein the one or more salts are selected from the group consisting of sodium chloride, sodium phosphates, sodium carbonates, sodium sorbates, sodium acetates, sodium lactates, sodium ascorbates, sodium glutaminates; potassium chloride, potassium phosphates, potassium carbonates, potassium sorbates, potassium acetates, potassium lactates, potassium ascorbates, and potassium glutaminates.

### Embodiment 25

The baking additive of any of embodiments 1-24, wherein the diluent particles comprise sodium chloride or potassium chloride.

### Embodiment 26

The baking additive of any of embodiments 1-25, wherein the diluent particles consist of sodium chloride or potassium chloride.

### Embodiment 27

The baking additive of any of embodiments 1-26, wherein the diluent particles comprise sodium chloride or potassium chloride, and a sugar binding agent.

### Embodiment 28

The baking additive of any of embodiments 1-27, wherein the diluent particles consist of sodium chloride or potassium chloride, and a sugar binding agent.

### Embodiment 29

The baking additive of any of embodiments 1-28, wherein the diluent particles comprise sucrose.

### Embodiment 30

The baking additive of any of embodiments 1-29, wherein the diluent particles consist of sucrose.

### Embodiment 31

The baking additive of any of embodiments 1-30, wherein the diluent particles comprise sodium ascorbate, potassium ascorbate, or ascorbic acid.

### Embodiment 32

The baking additive of any of embodiments 1-31, wherein the diluent particles consist of sodium ascorbate, potassium ascorbate, or ascorbic acid.

### Embodiment 33

The baking additive of any of embodiments 1-32, which further comprises ascorbic acid.

### Embodiment 34

The baking additive of any of embodiments 1-33, which has a dynamic angle of repose of less than 60°.

### Embodiment 35

The baking additive of any of embodiments 1-34, which has a dynamic angle of repose of less than 55°.

### Embodiment 36

The baking additive of any of embodiments 1-35, which has a dynamic angle of repose of less than 50°.

### Embodiment 37

A method for preparing a baking premix, comprising mixing flour and/or ascorbic acid, and the baking additive of any of embodiments 1-36.

### Embodiment 38

The method of embodiment 37, which further comprises adding water.

The present invention is further described by the following examples which should not be construed as limiting the scope of the invention.

### EXAMPLES

### Materials

Chemicals were commercial products of at least reagent grade.

Wheat flour (Farigel TM45, TM80 and TM120) was obtained from Westhove, France. Farigel is a hydrothermal treated wheat flour which is sieved to a narrow particle size distribution having a span of less than 2. It is available in different sizes.

Tapioca starch was obtained from Kreyenhop & Kluge GmbH & Co. KG, Germany.

NaCl was obtained from Akzo Nobel, NL and post sieved fractions were used for testing. Fine fraction was sieved through 150 μm sieve, medium fraction was between 150 μm and 250 μm, and the coarse fraction was above 250 μm; all sieved fractions having a span of less than 2.

Dedust, 35 (K), was obtained from AB Mauri (referred to as “Dedust” in the Examples) is a mixture of 40-50% w/w potato starch, 20-30% w/w wheat flour and 30-40% w/w sunflower oil.

### Enzymes

Fungamyl Ultra WF G (“Fungamyl”), was obtained from Novozymes.
Gluzyme mono conc BG (“Gluzyme”), was obtained from Novozymes.
Lipopan Xtra conc BG (“Lipopan”), was obtained from Novozymes.

Since the examples only investigated the release of dust, the exact enzymatic activity of the baking enzyme particles is not important. All baking enzyme particles were made by spray drying of an aqueous enzyme composition comprising a small amount of binder.

### Measuring the Dynamic Angle of Repose

The material is placed in a cylinder with at least one transparent end. The cylinder is rotated horizontally at a fixed speed and the observer watches the material moving within the rotating cylinder. The effect is similar to watching clothes tumble over one another in a slowly rotating clothes dryer. The granular material will assume a certain angle (“angle of repose”) as it flows within the rotating cylinder. This method is used to measure the dynamic angle of repose.

### Mixing of Samples

All samples, where the Dedust agent was used to distribute oil into a mix, were produced by adding diluent material, enzyme and Dedust agent into a 1 L bucket and subsequent mixing (shaking) in a paint shaker for 20 minutes.

Samples that were produced by adding liquid oil (sunflower oil, MCT oil, or rapeseed oil) were made by mixing diluent material, enzyme and oil in a Loedige 5 L high shear mixer (with knives) for 10 minutes.

### Measuring Enzyme Dust

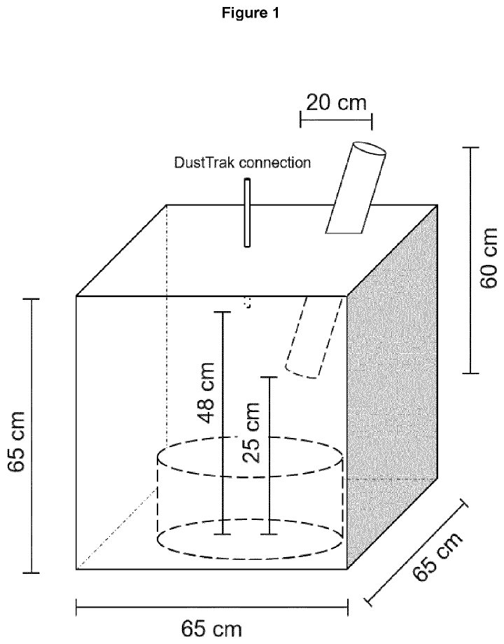

To measure the amount of released enzyme dust, a scooping box as shown in FIG. 1 was used. The design of the box allows dust measurements without any disturbance from external air turbulence sources. A controlled amount of powder is injected/dropped by gravity into a bucket at the bottom in the box (see FIG. 1). The standardized gravity injection of powder simulates the pouring of powder after scooping. Thus, the scooping box provides real-time information about how a dust cloud evolves after the powder has been dropped from a certain height.

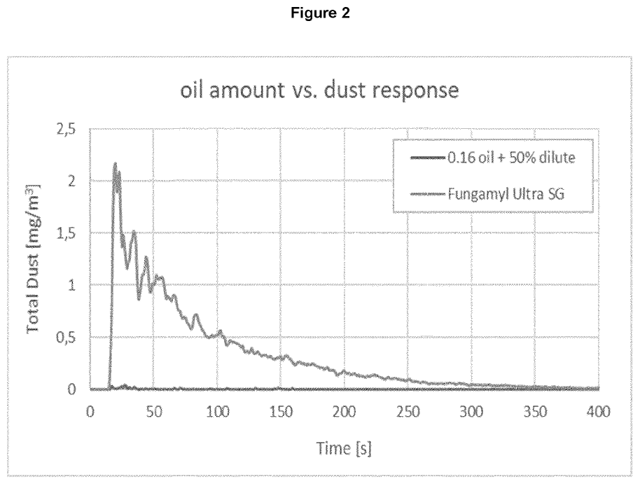

The dust cloud was detected and analyzed by using a dust monitor (DustTrak DRX Aerosol Monitor 8533) to measure the dust propagation in real time. FIG. 2 shows a typical dust profile of a commercial enzyme product, showing a fast increase in the dust concentration after the powder hit the bottom, followed by a settling period.

The total amount of detected enzyme dust is found by integrating the measured dust over time (“area under the curve”), which may also be expressed as a percentage of a reference sample.

### Example 1

Reducing Enzyme Dust with Oil

In this example the effect of oil on reduction of enzyme dust was tested. Various amounts of Dedust (˜40% sunflower oil) were mixed with Fungamyl and Farigel TM 80. The resulting enzyme dust profiles (measured with DustTrak DRX Aerosol Monitor 8533) were interpreted by calculating the area under the curve (AUC). Each sample consisted of Dedust, Fungamyl and Farigel TM80 (up to 100%).

TABLE 1
Dust monitor measurements.

| Sample | Oil (from Dedust) | Area under curve |
|---|---|---|
| [% w/w] | [% w/w] | [mg/m³] |
| 50% Fungamyl | 0 | 100% |
| 0.1% Dedust + 50% Fungamyl | 0.04 | 7.4% |
| 0.2% Dedust + 50% Fungamyl | 0.07 | 2.0% |
| 0.3% Dedust + 50% Fungamyl | 0.10 | 2.0% |
| 0.5% Dedust + 50% Fungamyl | 0.16 | 0.8% |
| 0.6% Dedust + 50% Fungamyl | 0.21 | 0.4% |
| 3.0% Dedust + 50% Fungamyl | 1.05 | 0.4% |

Table 1 shows that increasing amounts of oil results in lower amounts of enzyme dust. This can be seen from the “area under the curve”. The unchanged values of “area under curve” when using 0.21% and 1.05% oil indicate that the limit of detection was reached.

### Example 2

### Effect of Oil and Diluent Particles on Flowability

To evaluate the effect of oil and diluent particles on flowability, the dynamic angle of repose was determined for compositions with varying ratios of enzyme, oil and flour. This was done by filling 100 g test powder into a 0.25 L transparent plastic flask and placing the flask horizontally on a pair of rotating rollers to rotate the flask and the enclosed powder at 50 rpm. Before starting the roller, the powder height was marked with a cross at the bottom of the flask to adjust the angle ruler. When the rollers were started, the powder surface in the flask quickly reached a steady angle, and the dynamic angle of repose was measured with the ruler (see FIG. 3).

Each of the test samples consisted of Dedust, Fungamyl and Farigel TM80 (up to 100%), as shown in Table 2, which also shows the measured dynamic angle of repose of each sample.

TABLE 2
Dynamic angle of repose.

Dynamic angle of repose

| Fungamyl | 1.1% sunflower oil | 0.2% sunflower oil |
|---|---|---|
| [% w/w] | (3.0% Dedust) | (0.6% Dedust) |
| 70% | 71° | 60° |
| 60% | 65° | 57° |
| 50% | 59° | 52° |
| 25% | 56° | 45° |
| 13% | 48° | 40° |
| 6% | 39° | 33° |

The results in Table 2 show that a sample consisting of 70% enzyme particles, 0.2% sunflower oil, and diluent particles, retains a reasonable flowability. If more oil is used in the formulation, the amount of enzyme particles must be reduced to retain an acceptable flowability.

As shown in Table 2, a sample that contains 1.1% oil can only include up to 50% enzyme to achieve an acceptable flowability.

### Example 3

### Using the Stokes Diameter to Improve Flowability

As described above, the Stokes diameter is defined as follows:

$${d}_{stokes} = \sqrt{\frac{18 {μ}_{medium} {u}_{settle}}{g ( {ρ}_{particle} - {ρ}_{medium} )}}$$

To do the calculation, the values defining the Stokes diameter must to be determined. The fluid that was used for characterization was 2-propanol with a density of 781 kg/m³ (ρₚᵣₒₚₐₙₒₗ) and a viscosity of 0.002 Pa·s at 25° C. The gravity constant was 9.81 m/s². The temperature was kept at 25° C. to ensure constant density and viscosity.

Since the Stokes diameter depends on the fluid and particle density, the particle density was determined as follows:
i) The weight of a 100 mL (V_{flask}) short-necked volumetric flask was recorded (m_{flask}).
ii) 5-20 grams of the solid sample was weighed (mₛₐₘₚₗₑ) and added into the flask.
iii) The flask with the solid sample was filled with 2-propanol (air bubbles were removed in an ultrasonic device) and weighed (mₜₒₜₐₗ), and the weight of 2-propanol was determined:

mₚᵣₒₚₐₙₒₗ=mₜₒₜₐₗ−m_{flask}−mₛₐₘₚₗₑ.
iv) The volume of 2-propanol was calculated: Vₚᵣₒₚₐₙₒₗ=mₚᵣₒₚₐₙₒₗ/ρₚᵣₒₚₐₙₒₗ.
v) The volume of the solid sample was calculated: Vₛₐₘₚₗₑ=V_{flask}−Vₚᵣₒₚₐₙₒₗ.
vi) The density of the solid sample (particle) was calculated: ρₛₐₘₚₗₑ=mₛₐₘₚₗₑ/Vₛₐₘₚₗₑ

The settling velocity also needs to be determined. To do this, a 250 mL measuring cylinder was filled (1 cm free on top) with isopropyl alcohol (density: 785 kg/m³; viscosity: 0.002 Pa·s). Approximately 1 cm above the bottom of the cylinder a horizontal finish line was drawn. 20 cm above the finish line an additional starting line was drawn indicating time=0.

Before starting the analysis of the diluent particles, the particle size distribution and span were analyzed in a Malvern (Mastersizer 3000) device. Each sample was then sieved down to the d₅₀ value plus minus 50 μm.

The settling velocity was determined by adding a few particles (taken with small spoon) of the pre-sieved sample to the filled cylinder. Some of the powders needed a small distance to separate, therefore the time was first started after a specific particle crossed the starting line.

The time was stopped when the same particle crossed the finish line. By calculating the distance per time, the mean settling velocity of the diluent was calculated.

In Table 3 is shown several powder samples containing combinations of Fungamyl and diluents with different Stokes diameters. All combinations included 50% w/w Fungamyl, 49.4% w/w diluent, and 0.2% w/w sunflower oil (from Dedust).

Visual inspection of the sample containing “NaCl coarse” as diluent revealed segregation after tapping on the sample for a few seconds. The samples containing “NaCl fine”, “Farigel TM80” and “Farigel TM120” did not segregate after a similar treatment.

TABLE 3
Calculated Stokes diameters and resulting angle of repose and enzyme dust.

| | Particle | Diluent | Settling | ρ_{particle}- | | Dynamic | Area under |
|---|---|---|---|---|---|---|---|
| | size d₅₀ | density | velocity | ρ_{medium} | Stokes | angle of | curve |
| Diluent | [μm] | [kg/m³] | [m/s] | [kg/m³] | diameter | repose | [mg/m³] |
| Fungamyl | 140 | 1050 | 0.001 | 265 | 121 | 75°* | 1 |
| NaCl fine | 87 | 2150 | 0.009 | 1365 | 156 | 52° | 1 |
| NaCl medium | 180 | 2150 | 0.017 | 1365 | 216 | 69° | 2 |
| NaCl coarse | 301 | 2150 | 0.056 | 1365 | 389 | 87° | 1 |
| Farigel | 423 | 1450 | 0.017 | 665 | 309 | 68° | 1 |
| TM45 | | | | | | | |
| Farigel | 157 | 1450 | 0.005 | 665 | 166 | 50° | 3 |
| TM80 | | | | | | | |
| Farigel | 141 | 1450 | 0.005 | 665 | 158 | 50° | 1 |
| TM120 | | | | | | | |
| Tapioca | 30 | 1450 | 0.001 | 665 | 61 | 85° | 1 |
| starch | | | | | | | |

*99.4% w/w Fungamyl + 0.6% w/w Dedust

As shown in Table 3, not all diluent materials can be used to achieve a combination of high enzyme amount (>30% enzyme powder), acceptable flowability (dynamic angle of repose <60°), and low enzyme dust.

For example, coarse NaCl particles or Tapioca starch, which both have very different Stokes diameters compared to Fungamyl (389 μm to 121 μm respectively 61 μm to 121 μm), result in a final product that is very cohesive and not flowable; whereas the fine NaCl particles, Farigel TM80 or Farigel TM120 result in good flowability of the final product.

### Example 4

Reducing Enzyme Dust while Retaining Flowability and High Enzyme Activity

Different enzyme powders, oils and diluents were evaluated to compare the flowability and amount of enzyme dust.

From Tables 4 and 5, it can be seen that all of the added oils reduce the enzyme dust by orders of magnitudes, independent of the type of oil used. Also, the flowability was within the acceptable limit (<00°) when adding a diluent with the right Stokes diameter (see Table 3). The amount of enzyme in this experiment was kept constant at 50% w/w enzyme powder.

TABLE 4
Enzyme dust and flowability for different oils and diluents.

| | | | Dynamic | |
|---|---|---|---|---|
| | | | angle | Area under |
| Enzyme | Diluent | Oil | of repose | curve |
| Gluzyme | — | — | 34° | 100% |
| Gluzyme | 49.8% | 0.2% | 48° | 0.3% |
| | Farigel TM80 | Rapeseed oil | | |
| Gluzyme | 49.8% | 0.2% | 51° | 0.6% |
| | Farigel TM80 | MCT oil | | |
| Gluzyme | 49.4% | 0.2% | 50° | 1.1% |
| | NaCl fine | Sunflower oil | | |
| | | (from Dedust) | | |

TABLE 5
Enzyme dust and flowability for different oils and diluents.

| | | | Dynamic angle | Area under |
|---|---|---|---|---|
| Enzyme | Diluent | Oil | of repose | curve |
| Lipopan | — | — | 36° | 100% |
| Lipopan | 49.8% | 0.2% | 45° | 0.6% |
| | Farigel TM80 | Rapeseed oil | | |
| Lipopan | 49.8% | 0.2% | 47° | 0.1% |
| | Farigel TM80 | MCT oil | | |
| Lipopan | 49.4% | 0.2% | 53° | 0.2% |
| | NaCl fine | Sunflower oil | | |
| | | (from Dedust) | | |

1. A baking additive powder comprising, or consisting essentially of:
(a) 30-70% w/w of enzyme particles having a mass median diameter (D₅₀) of 20-200 μm,
(b) 0.05-5% w/w of oil, and
(c) non-enzymatic diluent particles having a Stokes diameter of 130-220 μm with a span of less than 2.

2. The baking additive of claim 1, wherein the enzyme particles comprise at least 0.1% w/w of active enzyme protein.

3. The baking additive of claim 1, wherein the enzyme particles are prepared by spray drying.

4. The baking additive of claim 1, wherein the enzyme particles have a mass median diameter (D₅₀) of 50-200 μm.

5. The baking additive of claim 1, which comprises 40-70% w/w of the enzyme particles.

6. The baking additive of claim 1, wherein the enzyme is selected from the group consisting of amylase, oxidase, lipolytic enzyme, and hemicellulase.

7. The baking additive of claim 1, wherein the oil comprises or consists of an edible vegetable oil.

8. The baking additive of claim 1, which comprises 0.07-3% of the oil.

9. The baking additive of claim 1, wherein the oil comprises or consists of an oil selected from the group consisting of sunflower oil, palm oil, coconut oil, MCT oil, soy oil, rapeseed oil, and canola oil.

10. The baking additive of claim 1, which comprises 20-69% w/w of the diluent particles.

11. The baking additive of claim 1, wherein the diluent particles have a particle density of more than 1500 kg/m³.

12. The baking additive of claim 1, wherein the diluent particles comprise, or consist of, one or more salts and/or sugars.

13. The baking additive of claim 1, which further comprises ascorbic acid.

14. The baking additive of claim 1, which has a dynamic angle of repose of less than 60°.

15. A method for preparing a baking premix, comprising mixing flour and/or ascorbic acid, and the baking additive of claim 1.

16. The baking additive of claim 1, wherein the enzyme particles have a mass median diameter (D₅₀) of 100-200 μm.

17. The baking additive of claim 1, wherein the diluent particles have a particle density of more than 1600 kg/m³.
